(19) United States
(12) Patent Application Publication
(10) Pub. No.: US 2025/0148074 A1
(43) Pub. Date: May 8, 2025

(54) Multistage Quarantine of Emails

(71) Applicant: SOPHOS LIMITED, Abingdon Oxfordshhire (GB)

(72) Inventors: John Mears, Carmarthen (GB); Balakrishnan Rajkumar, Chennai (IN)

(73) Assignee: SOPHOS LIMITED, Abingdon Oxfordshire (GB)

(21) Appl. No.: 18/503,920

(22) Filed: Nov. 7, 2023

(51) Int. Cl. G06F 21/55

(52) U.S. Cl. CPC G06F 21/554; G06F 2221/032

(57) ABSTRACT

A computer-implemented method includes receiving an email for processing. The method further includes prior to delivering the email, providing the email to a set of scanners, wherein one or more of the scanners are associated with a respective type of content and are configured to detect whether the email includes the respective type of content. The method further includes receiving, from the set of scanners, an identification of a plurality of types of content in the email. The method further includes for each type of content in the email providing the email to a user of a particular role, wherein users of the particular role are authorized to review the type of content and receiving, from the user, approval of the email for the type of content. The method further includes responsive to the email being approved for each type of content, delivering the email to a recipient.

### FIELD

Embodiments relate generally to automatically quarantining incoming emails with certain types of content until a review of the emails is completed. More particularly, embodiments relate to methods, systems, and computer-readable media that provide an email to users of particular roles that are authorized to review the email and provide an indication of approval based on a type of content in the email prior to delivering the email to a recipient.

### BACKGROUND

Secure email gateways work by processing a customer's inbound and outbound email with email scanners that detect different kinds of undesirable content. An email may stay in quarantine until the email is reviewed by administrators that deem the email to be harmless or low risk.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes receiving an email for processing. The method further includes prior to delivering the email, providing the email to a set of scanners, wherein one or more of the scanners: are associated with a respective type of content; and are configured to detect whether the email includes the respective type of content. The method further includes receiving, from the set of scanners, an identification of a plurality of types of content in the email. The method further includes for each type of content in the email: providing the email to a user of a particular role, wherein users of the particular role are authorized to review the type of content; and receiving, from the user, approval of the email for the type of content. The method further includes responsive to the email being approved for each type of content, delivering the email to a recipient.

In some embodiments, providing and receiving the approval is performed serially for different types of content and the method further includes after receiving the identification of the plurality of types of content in the email, determining that a policy has been updated for a particular type of content; and in response to the determining, providing the email to a scanner from the set of scanners configured to detect the particular type of content prior to providing the email to the user of the particular role. In some embodiments, an order in which the email is provided to users of particular roles is based at least in part on an amount of time associated with prior approvals for the respective type of content for which the users of the particular roles are authorized to review.

In some embodiments, the method further includes identifying a first user role that is authorized to review multiple types of content, where a number of types of content that the first user role is authorized to review is greater than a number of types of content that other user roles are authorized to review and where providing the email to the user of the particular role comprises providing the email to the user of the first user role prior to providing the email to users of other user roles. In some embodiments, the method further includes responsive to receiving the email, setting a content identifier for each type of content to false; and responsive to the email being reviewed for each type of content and the email being approved for each type of content, setting respective content identifiers to true. In some embodiments, multiple users are assigned to a particular type of content and the email stays in quarantine until it is approved by each of the multiple users. In some embodiments, the method further includes responsive to the respective type of content being for innocuous spam and bulk emails and the email not being reviewed for a predetermined amount of time while the email is reviewed for at least one other type of content, delivering the email to the recipient. In some embodiments, the method further includes determining that a threshold amount of time has passed since providing the email to be reviewed for a particular type of content; and providing the email to the scanner configured to rescan the email for the particular type of content. In some embodiments, the method further includes receiving a denial of approval for a particular email for at least one type of content, and in response to receiving the denial, discarding the email.

A device comprises one or more processors and one or more computer-readable media, having instructions stored thereon that, when executed by the one or more processors, cause the one or more processors to perform operations comprising: receiving an email for processing; prior to delivering the email, providing the email to a set of scanners, wherein one or more of the scanners: are associated with a respective type of content; and are configured to detect whether the email includes the respective type of content; receiving, from the set of scanners, an identification of a plurality of types of content in the email; for each type of content in the email: providing the email to a user of a particular role, wherein users of the particular role are authorized to review the type of content; and receiving, from the user, approval of the email for the type of content; and responsive to the email being approved for each type of content, delivering the email to a recipient.

In some embodiments, providing and receiving the approval is performed serially for different types of content, and the operations further include: after receiving the identification of the plurality of types of content in the email, determining that a policy has been updated for a particular type of content; and in response to the determining, providing the email to a scanner from the set of scanners configured to detect the particular type of content prior to providing the email to the user of the particular role. In some embodiments, an order in which the email is provided to users of particular roles is based at least in part on an amount of time associated with prior approvals for the respective type of content for which the users of the particular roles are authorized to review. In some embodiments, the operations further include: identifying a first user role that is authorized to review multiple types of content; where a number of types of content that the first user role is authorized to review is greater than a number of types of content that other user roles are authorized to review; and where providing the email to the user of the particular role comprises providing the email to the user of the first user role prior to providing the email to users of other user roles. In some embodiments, the operations further include responsive to receiving the email, setting a content identifier for each type of content to false; and responsive to the email being reviewed for each type of content and the email being approved for each type of content, setting respective content identifiers to true.

A non-transitory computer-readable medium with instructions stored thereon that, responsive to execution by a processing device, causes the processing device to perform operations comprising: receiving an email for processing; prior to delivering the email, providing the email to a set of scanners, wherein one or more of the scanners: are associated with a respective type of content; and are configured to detect whether the email includes the respective type of content; receiving, from the set of scanners, an identification of a plurality of types of content in the email; for each type of content in the email: providing the email to a user of a particular role, wherein users of the particular role are authorized to review the type of content; and receiving, from the user, approval of the email for the type of content; and responsive to the email being approved for each type of content, delivering the email to a recipient.

In some embodiments, providing and receiving the approval is performed serially for different types of content, and the operations further include: after receiving the identification of the plurality of types of content in the email, determining that a policy has been updated for a particular type of content; and in response to the determining, providing the email to a scanner from the set of scanners configured to detect the particular type of content prior to providing the email to the user of the particular role. In some embodiments, an order in which the email is provided to users of particular roles is based at least in part on an amount of time associated with prior approvals for the respective type of content for which the users of the particular roles are authorized to review. In some embodiments, the operations further include: identifying a first user role that is authorized to review multiple types of content; where a number of types of content that the first user role is authorized to review is greater than a number of types of content that other user roles are authorized to review; and where providing the email to the user of the particular role comprises providing the email to the user of the first user role prior to providing the email to users of other user roles. In some embodiments, the operations further include responsive to receiving the email, setting a content identifier for each type of content to false; and responsive to the email being reviewed for each type of content and the email being approved for each type of content, setting respective content identifiers to true. In some embodiments, multiple users are assigned to a particular type of content and the email stays in quarantine until it is approved by each of the multiple users.

The specification advantageously manages review and approval of an email by multiple users based on types of content included in the email.

### BRIEF DESCRIPTION OF THE DRAWINGS

FIG. 1 depicts a block diagram of a threat management system, according to some embodiments described herein.

FIG. 2 is a block diagram of an example computing device, according to some embodiments described herein.

FIG. 3 is an example user interface for an administrator that creates a quarantining policy, according to some embodiments described herein.

FIG. 4 is an example user interface for a user that is authorized to review multiple types of content, according to some embodiments described herein.

FIG. 5 is a flow diagram of an example method to orchestrate review of an email with multiple types of content, according to some embodiments described herein.

FIG. 6 is a flow diagram of another example method to orchestrate review of an email with multiple types of content, according to some embodiments described herein.

### DETAILED DESCRIPTION

Secure email gateways process a customer's inbound and outbound email through a set of scanners. In some configurations each scanner detects different kinds of undesirable content. For example, the types of content may include malicious attachments, such as viruses; emails that contain Uniform Resource Locators (URLs) that link to malicious websites, such as phishing attempts that mimic other websites in order to capture users' passwords; emails with senders that are spoofed so that emails appear to come from a different sender than reality; emails with content that contravenes policy, such as by disclosing confidential information, offensive emails, or emails containing personally identifiable data; emails with attachments, such as executables; etc.

When a scanner detects undesirable content, a variety of actions can be taken, as determined by a customer's policies. In cases of high confidence of detection by a scanner, the email may be blocked outright. However, in other situations, the email is quarantined. Quarantined emails are not immediately delivered; instead, they are stored in a queue or holding area. The email may stay in quarantine until the email is reviewed by administrators, e.g., of an information technology (IT) department, that deem the email to be harmless or low risk. In cases where an email includes different types of content that are reviewed by different people, management of the email becomes complex when an email cannot be released without being reviewed by multiple people.

A security application advantageously streamlines the process of approving emails for delivery by, for each type of content in an email, providing the email to a user of a particular role and receiving, from the user, approval of the email for the type of content. In some embodiments, the email is provided to users of particular roles based on an amount of time associated with prior approvals for the respective type of content for which the users of the particular roles are authorized to review. In some embodiments, for particular types of content, such as innocuous spam and bulk emails, if a time that the email is quarantined exceeds a predetermined amount of time, the security application may deliver the email to a recipient without explicit approval from a reviewer.

In some embodiments, an email, after being scanned by scanners, may be provided to different users serially and there may be a delay in review of the email during which a policy may be updated for a particular type of content. In this situation, the security application may provide the email to a scanner that is configured to detect the particular type of content before the email is provided to a second user that reviews emails for the particular type of content. This may be the first time that the email is provided to the scanner, based on an expected review time of other users, or the email may be scanned a second time based on the policy changing in the interim.

As a result of the above-described embodiments, the security application maintains a careful balance between security and efficiency for delivering emails to recipients. In particular, emails that are not flagged by automated scanners may be delivered without quarantining, enabling efficient communication. Emails that are flagged by one or more automated scanners may be queued for review in an efficient manner (e.g., that minimizes a total number of manual reviewers, minimizes a total review time, minimizes a delay in delivery of email, etc.). Further, upon determination that the risk associated with an email may be low (e.g., innocuous spam or bulk email), the email may be delivered without review. Further, upon determination that the email has been reviewed for particular types of dangerous content (e.g., an executable attachment, a link to malware, etc.) or for organization policy (e.g., confidential information) and approved, the email may be delivered without waiting for manual reviews for other types of content (e.g., when a sender identity is not verified, email has an attachment, etc.) to be completed. Various embodiments described herein improve email delivery and reduce computational load, e.g., by reducing the total number of emails to be reviewed manually (reducing computational resource utilization for such review), reducing a total number of emails stored in a queue or holding area (reducing memory or storage usage), by ensuring emails are reviewed with current version of policy and scanners (thus improving security), by automatically delivering emails upon a threshold level of approval (thus improving time to delivery), etc. Lastly, the technology advantageously reduces a number of times that an email is reviewed. For example, if an email contains three kinds of content, the email may be routed to a single reviewer that has the authority to provide approval for all three types of content.

### Threat Management System 100

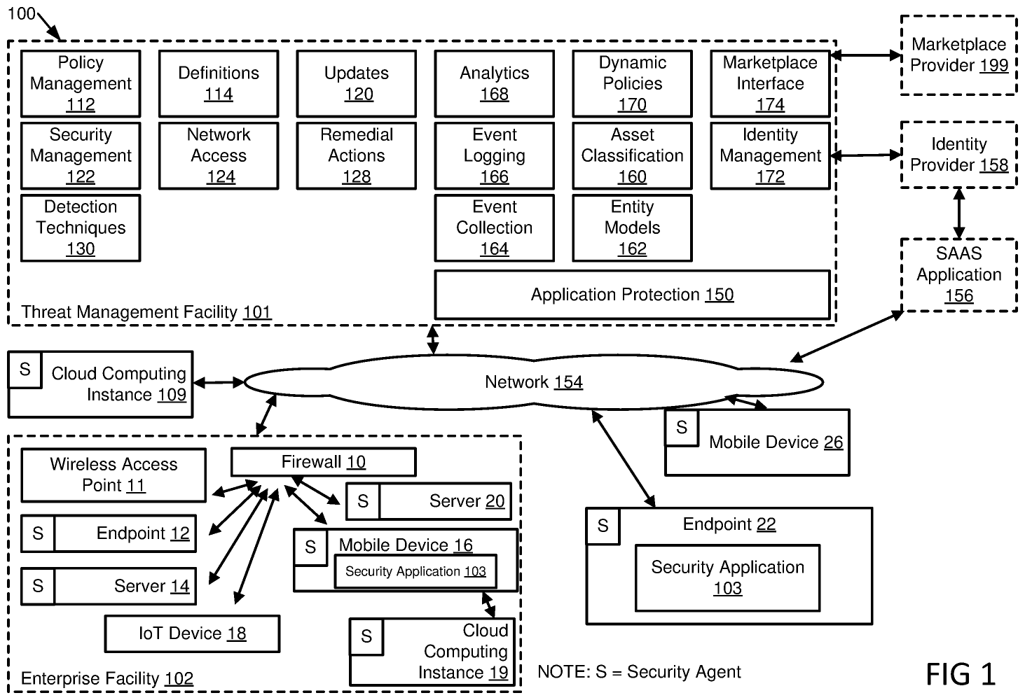

FIG. 1 depicts a block diagram of a threat management system 100 providing protection against a plurality of threats, such as malware, viruses, spyware, cryptoware, adware, ransomware, trojans, spam, intrusion, policy abuse, improper configuration, vulnerabilities, improper access, uncontrolled access, and more. A threat management facility or network monitor 100 may communicate with, coordinate, and control operation of security functionality at different control points, layers, and levels within the system 100. A number of capabilities may be provided by the threat management facility 101, with an overall goal to intelligently monitor network traffic from endpoints/hosts to known security product update sites. The threat management facility 101 can monitor the traffic passively and analyze the traffic. The threat management facility 101 may be or may include a gateway such as a web security appliance that is actively routing and/or assessing the network requests for security purposes. Another overall goal is to provide protection needed by an organization that is dynamic and able to adapt to changes in compute instances and new threats due to personal or unmanaged devices using the enterprise network. According to various aspects, the threat management facility 101 may provide protection from a variety of threats to a variety of compute instances in a variety of locations and network configurations.

As one example, users of the threat management facility 101 may define and enforce policies that control access to and use of compute instances, networks, and data. Administrators may update policies such as by designating authorized users and conditions for use and access. The threat management facility 101 may update and enforce those policies at various levels of control that are available, such as by directing compute instances to control the network traffic that is allowed to traverse firewalls and wireless access points, applications, and data available from servers, applications, and data permitted to be accessed by endpoints, and network resources and data permitted to be run and used by endpoints. The threat management facility 101 may provide many different services, and policy management may be offered as one of the services.

Turning to a description of certain capabilities and components of the threat management system 100, an example enterprise facility 102 may be or may include any networked computer-based infrastructure. For example, the enterprise facility 102 may be corporate, commercial, organizational, educational, governmental, or the like. As home networks can also include more compute instances at home and in the cloud, an enterprise facility 102 may also or instead include a personal network such as a home or a group of homes. The enterprise facility's 102 computer network may be distributed amongst a plurality of physical premises, such as buildings on a campus, and located in one or in a plurality of geographical locations. The configuration of the enterprise facility as shown as one example, and it will be understood that there may be any number of compute instances, less or more of each type of compute instances, and other types of compute instances.

As shown, the example enterprise facility includes a firewall 10, a wireless access point 11, an endpoint 12, a server 14, a mobile device 16, an appliance or Internet-of-Things (IoT) device 18, a cloud computing instance 19, and a server 20. One or more of 10-20 may be implemented in hardware (e.g., a hardware firewall, a hardware wireless access point, a hardware mobile device, a hardware IoT device, a hardware etc.) or in software (e.g., a virtual machine configured as a server or firewall or mobile device). While FIG. 1 shows various elements 10-20, these are for example only, and there may be any number or types of elements in a given enterprise facility. For example, in addition to the elements depicted in the enterprise facility 102, there may be one or more gateways, bridges, wired networks, wireless networks, virtual private networks, virtual machines or compute instances, computers, and so on.

The threat management facility 101 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policies facility 170, identity management facility 172, and marketplace management facility 174, as well as other facilities. For example, there may be a testing facility, a threat research facility, and other facilities. It should be understood that the threat management facility 101 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility. Some or all of one or more of the facilities 100, 112-174 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 109.

In various implementations, a marketplace provider 199 may make available one or more additional facilities to the enterprise facility 102 via the threat management facility 101. The marketplace provider may communicate with the threat management facility 101 via the marketplace interface facility 174 to provide additional functionality or capabilities to the threat management facility 101 and compute instances 10-26. As examples, the marketplace provider 199 may be a third-party information provider, such as a physical security event provider; the marketplace provider 199 may be a system provider, such as a human resources system provider or a fraud detection system provider; the marketplace provider may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122. According to some implementations, the marketplace provider 199 is a trusted security vendor that can provide one or more security software products to any of the compute instances described herein. In this manner, the marketplace provider 199 may include a plurality of trusted security vendors that are used by one or more of the illustrated compute instances.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

The identity provider 158 may provide user identity information, such as multi-factor authentication, to a software-as-a-service (SaaS) application. Centralized identity providers may be used by an enterprise facility instead of maintaining separate identity information for each application or group of applications, and as a centralized point for integrating multifactor authentication. The identity management facility 172 may communicate hygiene, or security risk information, to the identity provider 158. The identity management facility 172 may determine a risk score for a particular user based on events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

The threat protection provided by the threat management facility 101 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth. In some implementations, the endpoint 22 and/or the mobile device 26 include a security application 103 that is discussed in greater detail below.

In some implementations, compute instances 10-26 may communicate with cloud applications, such as SaaS application 156. The SaaS application 156 may be an application that is used by but not operated by the enterprise facility 102. Example commercially available SaaS applications 156 include Salesforce, Amazon Web Services (AWS) applications, Google Apps applications, Microsoft Office 365 applications, and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network or combination of these.

Aspects of the threat management facility 101 may be provided as a stand-alone solution. In other implementations, aspects of the threat management facility 101 may be integrated into a third-party product. An application programming interface (e.g., a source code interface) may be provided such that aspects of the threat management facility 101 may be integrated into or used by or with other applications. For instance, the threat management facility 101 may be stand-alone in that it provides direct threat protection to an enterprise or computer resource, where protection is subscribed to directly. Alternatively, the threat management facility may offer protection indirectly, through a third-party product, where an enterprise may subscribe to services through the third-party product, and threat protection to the enterprise may be provided by the threat management facility 101 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In some implementations, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of application protection 150 provided by the cloud, and so on.

In an implementation, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an implementation, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, uniform resource identifier (URI) filtering, and the like. Aspects of the web security and control may be provided, for example, in the security agent of an endpoint 12, in a wireless access point 11 or firewall 10, as part of application protection 150 provided by the cloud, and so on.

According to one implementation, the security management facility 122 may provide for network monitoring and access control, which generally controls access to and use of network connections, while also allowing for monitoring as described herein. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. According to various implementations, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 101 or other network resource(s).

The security management facility 122 may also provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

The security management facility 122 may provide also for reputation filtering, which may target or identify sources of known malware. For instance, reputation filtering may include lists of URIs of known sources of malware or known suspicious internet protocol (IP) addresses, code authors, code signers, or domains, that when detected may invoke an action by the threat management facility 101. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In some implementations, some reputation information may be stored on a compute instance 10-26, and other reputation data available through cloud lookups to an application protection lookup database, such as may be provided by application protection 150.

In some implementations, information may be sent from the enterprise facility 102 to a third party, such as a security vendor, or the like, which may lead to improved performance of the threat management facility 101. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. Feedback may enable the evaluation or profiling of client actions that are violations of policy that may provide a predictive model for the improvement of enterprise policies as well as detection of emerging security threats.

An update management facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In some implementations, updates may be provided to the enterprise facility's 102 network, where one or more compute instances on the enterprise facility's 102 network may distribute updates to other compute instances.

According to some implementations, network traffic associated with the update facility functions may be monitored to determine that personal devices and/or unmanaged devices are appropriately applying security updates. In this manner, even unmanaged devices may be monitored to determine that appropriate security patches, software patches, virus definitions, and other similar code portions are appropriately updated on the unmanaged devices.

The threat management facility 101 may include a policy management facility 112 that manages rules or policies for the enterprise facility 102. Example rules include access permissions associated with networks, applications, compute instances, users, content, data, and the like. The policy management facility 112 may use a database, a text file, other data store, or a combination to store policies. A policy database may include a block list, a black list, an allowed list, a white list, and more. As non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Example policies may be defined for an enterprise facility, application type, subset of application capabilities, organization hierarchy, compute instance type, user type, network location, time of day, connection type, or any other suitable definition. Policies may be maintained through the threat management facility 101, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In one implementation, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

The threat management facility 101 may provide configuration management as an aspect of the policy management facility 112, the security management facility 122, or a combination thereof. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of uniform serial bus (USB) disks, and policy management 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

The policy management facility 112 may also require update management (e.g., as provided by the update facility 120). Update management for the security facility 122 and policy management facility 112 may be provided directly by the threat management facility 101, or, for example, by a hosted system. In some implementations, the threat management facility 101 may also provide for patch management, where a patch may be an update to an operating system, an application, a system tool, or the like, where one of the reasons for the patch is to reduce vulnerability to threats.

In some implementations, the security facility 122 and policy management facility 112 may push information to the enterprise facility 102 network and/or the compute instances 10-26, the enterprise facility 102 network and/or compute instances 10-26 may pull information from the security facility 122 and policy management facility 112, or there may be a combination of pushing and pulling of information. For example, the enterprise facility 102 network and/or compute instances 10-26 may pull update information from the security facility 122 and policy management facility 112 via the update facility 120, an update request may be based on a time period, by a certain time, by a date, on demand, or the like. In another example, the security facility 122 and policy management facility 112 may push the information to the enterprise facility's 102 network and/or compute instances 10-26 by providing notification that there are updates available for download and/or transmitting the information. In one implementation, the policy management facility 112 and the security facility 122 may work in concert with the update management facility 120 to provide information to the enterprise facility's 102 network and/or compute instances 10-26. In various implementations, policy updates, security updates, and other updates may be provided by the same or different modules, which may be the same or separate from a security agent running on one of the compute instances 10-26. Furthermore, the policy updates, security updates, and other updates may be monitored through network traffic to determine if endpoints or compute instances 10-26 correctly receive the associated updates.

As threats are identified and characterized, the definition facility 114 of the threat management facility 101 may manage definitions used to detect and remediate threats. For example, identity definitions may be used for recognizing features of known or potentially malicious code and/or known or potentially malicious network activity. Definitions also may include, for example, code or data to be used in a classifier, such as a neural network or other classifier that may be trained using machine learning. Updated code or data may be used by the classifier to classify threats. In some implementations, the threat management facility 101 and the compute instances 10-26 may be provided with new definitions periodically to include most recent threats. Updating of definitions may be managed by the update facility 120 and may be performed upon request from one of the compute instances 10-26, upon a push, or some combination. Updates may be performed at a specific a time period, on demand from a device 10-26, upon determination of an important new definition or a number of definitions, and so on.

A threat research facility (not shown) may provide a continuously ongoing effort to maintain the threat protection capabilities of the threat management facility 101 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 101 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need-to-know data, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In some implementations, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access rule facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 101 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 162. The entity models may be used, for example, to determine the events that are generated by assets. For example, some operating systems may provide useful information for detecting or identifying events. For examples, operating systems may provide process and usage information that are accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. An example event may be communication of a specific packet over the network. Another example event may be identification of an application that is communicating over a network. These and other events may be used to determine that a particular endpoint includes or does not include actively updated security software from a trusted vendor.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility 122. Observations or inferences about events may also be logged by the event logging facility 166.

When a threat or other policy violation is detected by the security management facility 122, the remedial action facility 128 may be used to remediate the threat. Remedial action may take a variety of forms, including collecting additional data about the threat, terminating or modifying an ongoing process or interaction, sending a warning to a user or administrator from an IT department, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 122 may take any steps or deploy any measures suitable for addressing a detection of a threat, potential threat, policy violation or other event, code or activity that might compromise security of a computing instance 10-26 or the enterprise facility 102.

### Computing Device 200

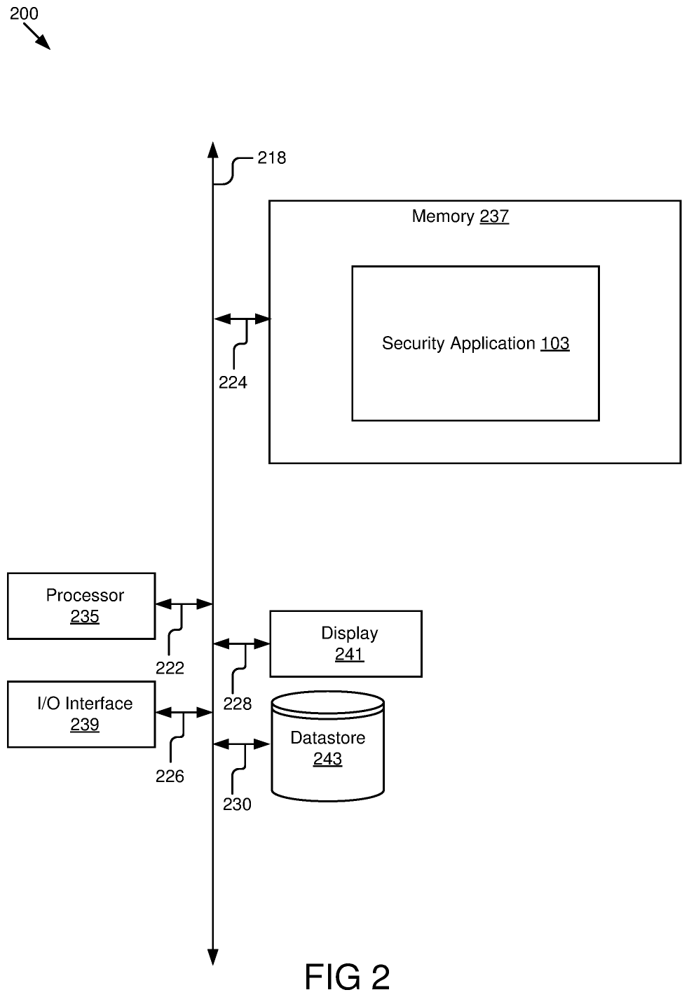

FIG. 2 is a block diagram of an example computing device 200 that may be used to implement one or more features described herein. Computing device 200 can be any suitable computer system, server, or other electronic or hardware device. In some embodiments, computing device 200 is part of the enterprise facility 102 in FIG. 1. For example, the computing device may be the mobile device 16, the server 13, the server 20, etc. In some embodiments, the computing device 200 is the endpoint 22 illustrated in FIG. 1.

In some embodiments, computing device 200 includes a processor 235, a memory 237, an input/output (I/O) interface 239, a display 241, and a datastore 243, all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, and the datastore 243 may be coupled to the bus 218 via signal line 230.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200.

The memory 237 may be a computer-readable media that stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the security application 103, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or datastore 243), and input/output devices can communicate via I/O interface 239. In another example, the I/O interface 239 can receive data, such as email messages, from a user device 115 and deliver the data to the security application 103. In some embodiments, the I/O interface 239 can connect to interface devices such as input devices (keyboard, pointing device, touchscreen, microphone, camera, scanner, sensors, etc.) and/or output devices (display devices, speaker devices, printers, monitors, etc.).

Some examples of interfaced devices that can connect to I/O interface 239 can include a display 241 that can be used to display content, e.g., an email message received from the sender. The display 241 can include any suitable display device such as a liquid crystal display (LCD), light emitting diode (LED), or plasma display screen, cathode ray tube (CRT), television, monitor, touchscreen, three-dimensional display screen, or other visual display device.

The datastore 243 may store data related to the security application 103. For example, the datastore 243 may store, with user permission, emails, corresponding determinations from the set of scanners, approvals from users of particular roles, content identifiers and corresponding true or false designations, etc. The datastore 243 may be coupled to the bus 218 via signal line 230.

In some embodiments, one or more components of the computing device 200 may not be present depending on the type of computing device 200. For example, if the computing device 200 is a server, the computing device 200 may not include the display 241.

### Example Security Application 103

FIG. 2 illustrates a computing device 200 that executes an example security application 103 stored in memory 237 of the computing device 200. The security application 103 may receive an email for processing by a set of automated scanners. Processing includes receiving an inbound email and processing the email before it is delivered to a recipient associated with the company. For example, the inbound email may be processed to ensure that the email does not contain a virus (e.g., based on automatically determining if the email content matches a known virus signature). Processing also includes receiving an outbound email and processing the email before allowing the email to be delivered to a recipient (e.g., to determine whether the email includes content that is prohibited to be included in outgoing emails, e.g., confidential content, offensive content, etc.). The outbound email may be delivered to a recipient within an organization associated with the security application 103 or externally. For example, the outbound email may be processed to ensure that company confidential information is not distributed externally.

Prior to delivering the email, the security application 103 provides the email to a set of scanners. For example, the scanners can include automated scanning software (and/or hardware) that is configured to analyze the email content (e.g., email headers, metadata, email content, email attachments, etc.) and provide a verdict.

In some embodiments, the set of scanners scan email messages for content and extract features from the email messages. Feature extraction is an automated process using one or more techniques such as text analysis, image analysis, video analysis, or other techniques to extract features from email content and/or metadata. Feature extraction is performed with user permission. Feature extraction can be performed using any suitable techniques such as machine learning, heuristics, pattern matching, hashing, etc.

In some embodiments, one or more scanners in the set of scanners are associated with a respective type of content and are configured to detect whether the email includes the respective type of content responsive to performing feature extraction. In some embodiments, the one or more scanners perform feature extraction by extracting metadata including identifying a sender, a recipient, an envelope, a header, etc. In some embodiments, the one or more scanners extract raw per-email data that includes identity vectors for the sender and all intermediate relays (public and private), Autonomous System Numbers (ASN), Domain Name System (DNS) hosting, and sender and intermediary authentication results.

Each scanner may apply different types of detection rules based on the type of content. In some embodiments, a scanner provides a verdict based on multiple factors, such as content of an email, senders and recipients of the email, a time of day, a reputation and history of emails relating to the sender and/or the recipient, metadata including a sender server or originating internet protocol (IP) address, and/or intermediate relay servers. A scanner may use any combination of whitelists, blacklists, machine learning, historical analysis, heuristics, pattern matching, etc. to analyze whether the email includes suspicious content for the respective type of content. For example, a first scanner may detect that inbound emails include innocuous spam. A second scanner may detect that inbound emails include malicious content, such as a virus, malicious spam, a malicious URL, a spoofed sender, etc. A third scanner may detect that outbound emails include company confidential information. A fourth scanner may detect that that inbound emails and/or outbound emails contain personally identifiable information. A fifth scanner may detect that inbound emails and/or outbound emails contain offensive language. Other numbers and types of scanners may be used.

In some embodiments, one or more of the scanners may be associated with two, three, or more types of content, and may provide respective verdicts. For example, a particular scanner may be configured to provide verdicts regarding whether an email includes confidential content of an organization, whether the email includes content that violates organizational policy (e.g., offensive content), and whether the email has a recipient that violates organizational policy (e.g., an unauthorized recipient). In another example, a particular scanner that scans text content may be configured to provide verdicts regarding whether the email text is malicious (e.g., includes phishing text, includes hyperlinks that are inauthentic, etc.) or suspicious (e.g., based on spelling errors, use of special characters, etc. in the body of the email).

The number of scanners and the types of content reviewed by the scanners are dictated by a policy. The policy may include default settings that are associated with the security application 103 or the policy may be configured by a company or organization, for example, by an administrator as discussed in greater detail with reference to the policy management facility 112 illustrated in FIG. 1. In some embodiments, scanners generate a confidence score for each type of content that indicates a level of confidence in the problematic nature of the type of content. For example, for a scanner that identifies types of offensive content, the scanner may determine that the language is offensive based on types of words used and frequency and assign a confidence score 98 out of 100. In some embodiments, the security application 103 may automatically discard an email if the confidence score from one or more scanners meets a threshold confidence value. If the confidence score falls below the threshold confidence value, the security application 103 may determine that a user of a particular role should review the email to determine if the email should be discarded, for example, based on the offensive language included in the email.

The security application 103 receives, from the set of scanners, an identification of a plurality of types of content in the email. The security application 103 may also receive a separate confidence score for each type of content in the email. If the confidence scores fail to meet the confidence value threshold, the email may need to be reviewed by users. For each type of content in the email, the security application 103 provides the email to a user of a particular role. Multiple users of the particular role may be authorized to review the type of content to prevent a backlog that may result if only one user was responsible for reviewing and approving all email for a particular type of content.

Users associated with different types of user roles may be authorized to review the type of content in the queue or holding area. For example, both an inbound email's recipient and administrators may be able to view innocuous spam and bulk emails from the first scanner by interacting with a user interface that displays the contents of the queue or holding area. In another example, both the inbound email's recipient and administrators may be able to view inbound emails that include malicious content from the second scanner. In another example, the administrator and/or a company's legal department may be able to view outbound emails containing company confidential information from the third scanner. In another example, a company's legal department and the sender or recipient may be able to view inbound emails and/or outbound emails that include personally identifiable information from the third scanner. In yet another example, a company's human resource manager may be able to view inbound emails and/or outbound emails that include offensive language.

Users associated with different types of user roles may have different types of authorization. For example, an email recipient or email sender may have the authority to review and release low-risk emails, such as spam and bulk emails. A Chief Information Security Officer (CISO) may have broad authority to review low-risk emails and approve malicious emails, such as attachments, URLs, and low-risk emails. An HR manager may have narrower authority than a CISO that is very specific to a type of content that concerns HR, such as the authority to review and approve emails containing offensive language.

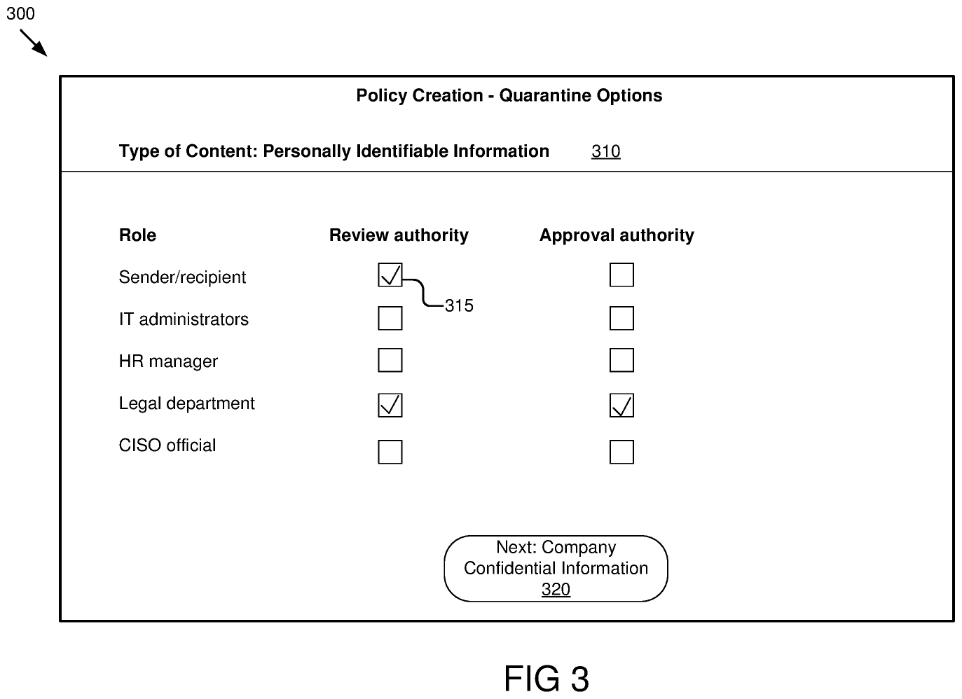

Turning to FIG. 3, an example user interface 300 for an administrator that creates a quarantining policy is illustrated. In this example, the administrator that creates a quarantine policy for a company selects permissions for users associated with a particular role for personally identifiable information 310 by selecting checkboxes. The administrator gives review authority to senders and/or recipients of emails that include personally identifiable information by checking a box 315. The senders and/or recipients do not have the authority to approve emails with personally identifiable information. The legal department has the authority to review and approve emails with personally identifiable information. The sender and/or recipient is restricted from having approval authority for personally identifiable information because they may not appreciate the legal ramifications of sharing personally identifiable information. For example, if a sender works for a university, the administrator may want to create a policy that limits the sharing of personally identifiable information to prevent the sender from exposing the university to legal liability by violating privacy laws. Although FIG. 3 illustrates a distinction between review authority and approval authority, in some embodiments any user that has review authority also has approval authority.

Once the user is done with selecting roles that have review authority and approval authority for personally identifiable information, the user may select a button for selecting permissions for company confidential information 320.

For each type of content in the email, the security application 103 receives approval or disapproval of the email. For example, an inbound email's recipient may be able to view the email in quarantine and confirm that they are interested in receiving the inbound email. In some embodiments where content identifiers for types of content were set to false, each time an email is reviewed and approved for a type of content, the respective content identifier is set to true.

In some embodiments, the users that are authorized to review the type of content may be different from the users that are authorized to approve or disapprove the email. For example, an email's recipient may not be able to confirm that they are interested in receiving the inbound email, but an administrator may analyze the inbound email, discover that it is a false positive, and approve the email for delivery. In another example, where an email contains company confidential information, an administrator or the legal department may be able to approve the email for delivery. In some embodiments, the approval of outbound emails that include particular words as dictated by the policy is limited to members of the legal department.

An email may include multiple types of content that are reviewed by multiple users that are authorized to review the respective types of content. In some embodiments, multiple users are assigned to a particular type of content and emails stay in quarantine until they are approved by each of the multiple users that are assigned to the particular type of content. For example, a particular type of content may be reviewed by both a human resources manager and an administrator from the IT department.

In some embodiments, the security application 103 identifies a first user role that is authorized to review multiple types of content. If a number of types of content that the first user role is authorized to review is greater than a number of types of content that other user roles are authorized to review, the security application 103 may provide an email to the user of the first user role prior to providing the email to users of other user roles. This advantageously reduces the time that the email stays in quarantine by reducing the number of users that have to approve the email before it is delivered to a recipient.

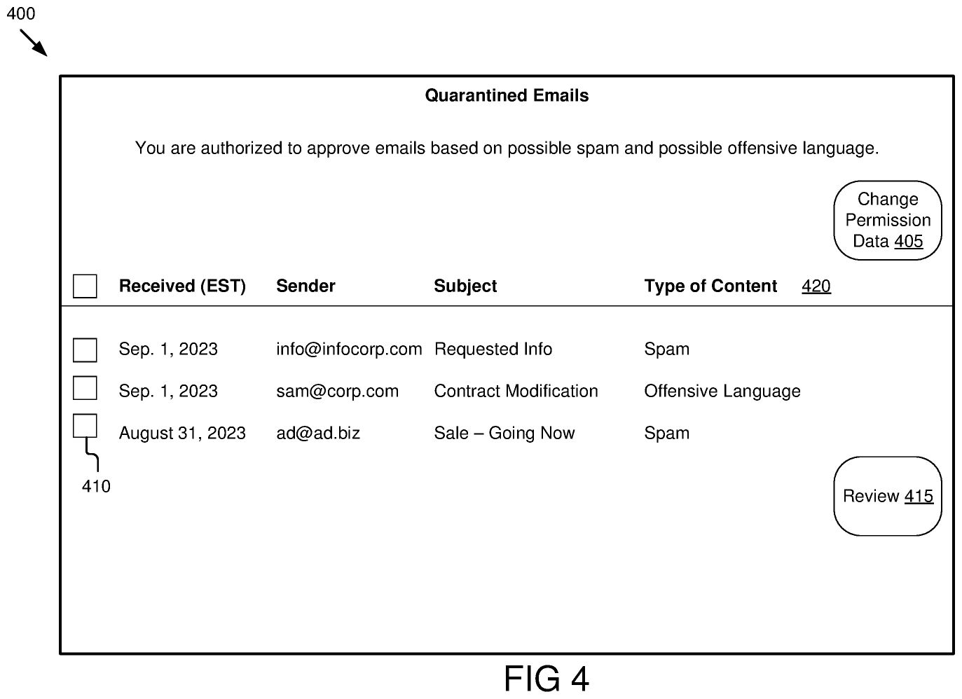

Turning to FIG. 4, a user interface 400 for a user that is authorized to review multiple types of content is illustrated. The user interface 400 is designed for a user that is authorized to approve emails for types of content that include spam and offensive language. In some embodiments, a user may request a change to the authorization by selecting a change permission data button 405. For example, the user may ask for increased authority to approve emails for types of content in addition to spam and offensive language.

The user interface 400 includes a list of emails that are waiting for the user to review and provide or deny approval. The user may select any of the checkboxes 410 and select the review button 415 to review the emails. The header 420 divides the email according to when the email was received, the name of the sender, the subject of the emails, and the type of content.

Once an email is approved for each type of content, the security application 103 delivers the email to a recipient. In some embodiments, if the email is denied approval for at least one type of content, the email is discarded and not delivered to the recipient.

The email may be reviewed serially or in parallel. When the email is reviewed serially, enough time may pass between when a first user associated with a first type of content reviews the email and when a second user associated with a second type of content reviews the email that a policy is updated for the second type of content. In some embodiments, in response to determining that a policy has been updated for a particular type of content, the email is provided to a scanner configured to detect the particular type of content prior to providing the email to the user of the second role (e.g., the second user in the previous scenario).

In another example, while waiting for a user to review a particular type of content, enough time may pass that it is likely that a policy has changed. Thus, in some embodiments, the security application 103 determines that a threshold amount of time has passed since providing the email to be reviewed for a particular type of content and the email is provided to a scanner configured to rescan the email for the particular type of content.

In some embodiments and with user permission, the security application 103 tracks a time it takes each user to review an email for a particular type of content. The security application 103 may determine an average review time of email for each user for each type of content. In some embodiments, the security application 103 assigns emails to particular users based on the review times.

In some embodiments, the security application 103 tracks an amount of time it takes for users of particular roles (e.g., an average time, a median time, etc.) to review respective types of content. For example, an IT department may have a larger number of administrators dedicated to the task of reviewing emails than the HR department or the legal department have assigned to review emails. As a result, the security application may provide the email to users of particular roles in an order based at least in part on the amount of time associated with prior approvals for the respective type of content for which the users of the particular roles are authorized to review.

An email may contain certain types of content that are not harmful if the security application 103 delivers the email to a recipient. For example, innocuous spam and bulk emails may be annoying, but are not harmful. In some embodiments, if the respective type of content is innocuous spam and/or bulk emails and an email is not reviewed for a predetermined amount of time while the email is reviewed and approved for at least one other type of content, such as for containing company confidential information, the security application 103 may deliver the email to the recipient.

### Example Methods

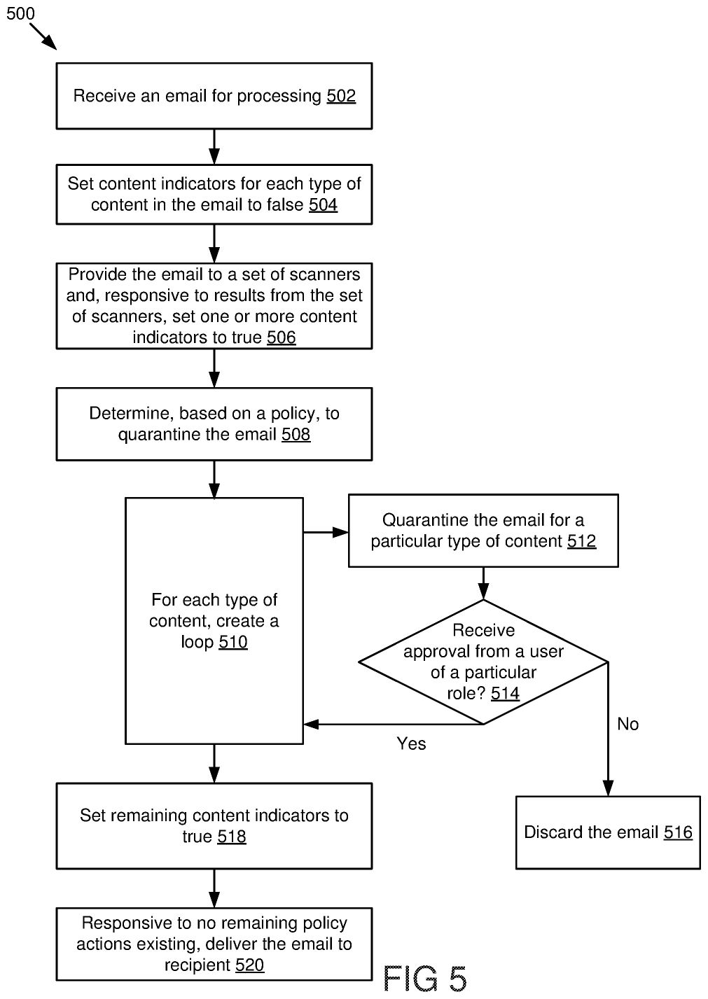

FIG. 5 is a flow diagram of an example method 500 to orchestrate review of an email with multiple types of content. The method 500 may be performed by a computing device 200 that includes a security application 103.

The method 500 may begin at block 502. At block 502, an email is received for processing. Block 502 may be followed by block 504.

At block 504, content indicators for each type of content in the email are set to false. Block 504 may be followed by block 506.

At block 506, the email is provided to a set of scanners and, responsive to results from the set of scanners, setting one or more content indicates to true. For example, an email may include five types of content: innocuous spam/bulk emails, emails with malicious content, emails with company confidential information, emails containing personally identifiable information, and emails containing offensive language. The set of scanners may indicate that an email needs to be reviewed for potentially including malicious content and for potentially including offensive language. As a result, the set of scanners changes the content indicators for spam/bulk emails, emails with company confidential information and emails containing personally identifiable information from false to true. Other embodiments may be used. For example, in some embodiments, the security application 103 does not initially set content indicators to false and instead changes the content indicators from true to false in response to receiving results from the scanner. Block 506 may be followed by block 508.

At block 508, a determination is made, based on a policy, to quarantine the email. In some embodiments, the security application 103 generates a confidence score for the email that indicates a confidence in a determination that the set of scanners properly categorized the email. If the confidence score fails to meet a confidence threshold value as defined by the policy, the security application 103 determines to quarantine the email. Block 508 may be followed by 510.

At block 510, a loop is created for each type of content that is described with reference to blocks 512 to 516. At block 512, the email is quarantined for the particular type of content. For example, the security application 103 isolates an email to be reviewed for the particular type of content, such as potentially offensive language. Block 512 may be followed by block 514.

At block 514, it is determined whether approval is received from a user of a particular role. For example, the security application 103 determines whether approval has been received for the portion of the email that potentially includes malicious content. If the user does not approve the email, block 514 may be followed by block 516. At block 516, the email is discarded.

If the user approves the email, block 514 may be followed by block 510, which moves onto the next type of content that is waiting for approval. The review of the email for different types of content may occur serially or in parallel. The loop from blocks 510 to 516 is continued until the email is approved for all types of content or at least one type of content is disapproved, in which case the process stops because the email is discarded. Once the loop is complete, block 510 may be followed by block 518.

At block 518, remaining content indicators are set to true. Block 518 may be followed by block 520.

At block 520, responsive to no remaining policy actions existing, the email is delivered to the recipient.

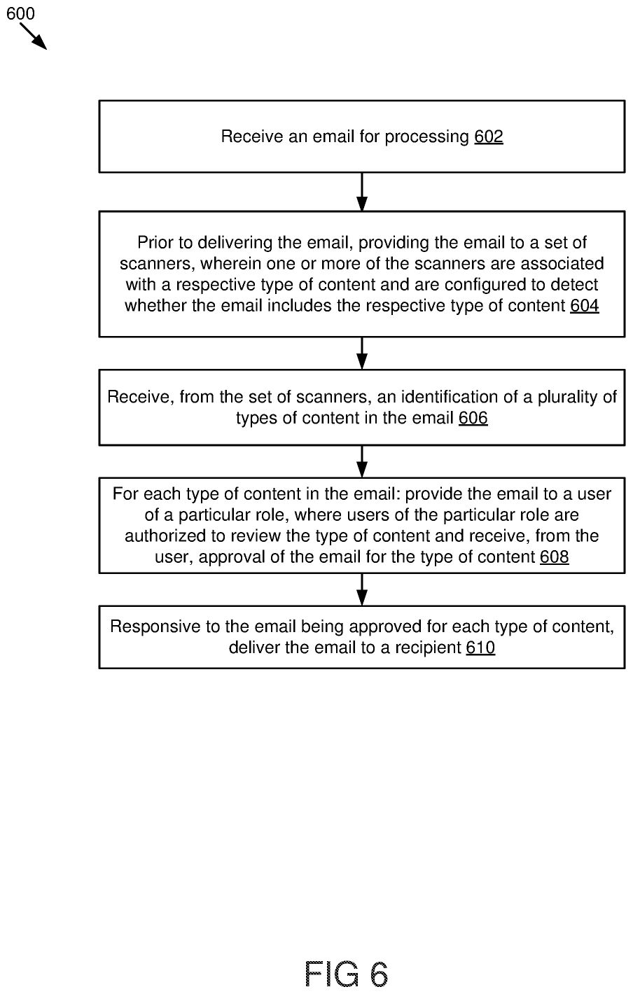

FIG. 6 is a flow diagram of an example method 600 to determine whether an email is suspicious. The method 600 may be performed by a computing device 200 that includes a security application 103.

The method 600 may begin at block 602. At block 602, an email is received for processing. In some embodiments, the method 600 may further include responsive to receiving the email, setting a content identifier for each type of content to false and responsive to the email being reviewed for each type of content and the email being approved for each type of content, setting respective content identifiers to true. Block 602 may be followed by block 604.

At block 604, prior to delivering the email, the email is provided to a set of scanners, where one or more of the scanners are associated with a respective type of content and are configured to detect whether the email includes the respective type of content. Block 604 may be followed by block 606.

At block 606, an identification of a plurality of types of content is received from the set of scanners. Block 606 may be followed by block 608.

At block 608, for each type of content in the email, the email is provided to a user of a particular role, where users of the particular role are authorized to review the type of content and receive, from the user, approval of the email for the type of content. An order in which the email is provided to users of particular roles may be based at least in part on an amount of time associated with prior approvals for the respective type of content for which the users of the particular roles are authorized to review. Multiple users may be assigned to a particular type of content, in which case the email remains in quarantine until it is approved by each of the multiple users.

In some embodiments, the process of providing an email and receiving approval of the email is performed serially for different types of content and the method 600 further includes determining that a policy has been updated for a particular type of content and in response to the determining, providing the email to the scanner configured to detect the particular type of content prior to providing the email to the user of the particular role.

In some embodiments, a first user role is identified that is authorized to review multiple types of content. If a number of types of content that the first user role is authorized to review is greater than a number of types of content that other user roles are authorized to review, then the email may be provided to the user of the first role prior to providing the email to users of other user roles.

In some embodiments, the security application 103 determines that it takes too long for users to review the email and the email is delivered without all the approvals. For example, responsive to the respective type of content being for innocuous spam and bulk emails and the email not being reviewed for a predetermined amount of time while the email is reviewed for at least one other type of content, delivering the email to the recipient. In some embodiments, a threshold amount of time is determined to have has passed since providing the email to be reviewed for a particular type of content and the email is provided to the scanner configured to rescan the email for the particular type of content. As a result, the scanner review is kept current. Block 608 may be followed by block 610.

At block 610, responsive to the email being approved for each type of content, the email is delivered to a recipient. If the user denies a type of content for a particular email for at least one type of content, in response to receiving the denial, the email is discarded.

Various embodiments described herein perform automated computer-based analysis of email messages, including message content and metadata. Such automated analysis is performed with explicit user permission, in compliance with applicable laws and regulations. No content is shared with a third-party or reviewed by a human, other than those authorized by users. For example, the described techniques may be implemented in a security platform that performs automated scanning and threat mitigation. The security platform is configurable and may include various privacy settings. The security platform may be implemented by an email recipient organization, such as an organization (company, university, non-profit, government, etc.) and/or an email service provider. Email messages and/or features extracted from email messages may be stored and utilized in accordance with user-permitted settings.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving an email for processing;
prior to delivering the email, providing the email to a set of scanners, wherein one or more of the scanners:
are associated with a respective type of content; and
are configured to detect whether the email includes the respective type of content;
receiving, from the set of scanners, an identification of a plurality of types of content in the email;
for each type of content in the email:
providing the email to a user of a particular role, wherein users of the particular role are authorized to review the type of content; and
receiving, from the user, approval of the email for the type of content; and
responsive to the email being approved for each type of content, delivering the email to a recipient.

2. The method of claim 1, wherein providing and receiving the approval is performed serially for different types of content, and wherein the method further comprises:
after receiving the identification of the plurality of types of content in the email, determining that a policy has been updated for a particular type of content; and
in response to the determining, providing the email to a scanner from the set of scanners configured to detect the particular type of content prior to providing the email to the user of the particular role.

3. The method of claim 1, wherein an order in which the email is provided to users of particular roles is based at least in part on an amount of time associated with prior approvals for the respective type of content for which the users of the particular roles are authorized to review.

4. The method of claim 1, further comprising:
identifying a first user role that is authorized to review multiple types of content;
wherein a number of types of content that the first user role is authorized to review is greater than a number of types of content that other user roles are authorized to review; and
wherein providing the email to the user of the particular role comprises providing the email to the user of the first user role prior to providing the email to users of other user roles.

5. The method of claim 1, further comprising:
responsive to receiving the email, setting a content identifier for each type of content to false; and
responsive to the email being reviewed for each type of content and the email being approved for each type of content, setting respective content identifiers to true.

6. The method of claim 1, wherein multiple users are assigned to a particular type of content and the email stays in quarantine until it is approved by each of the multiple users.

7. The method of claim 1, further comprising responsive to the respective type of content being for innocuous spam and bulk emails and the email not being reviewed for a predetermined amount of time while the email is reviewed for at least one other type of content, delivering the email to the recipient.

8. The method of claim 1, further comprising:
determining that a threshold amount of time has passed since providing the email to be reviewed for a particular type of content; and
providing the email to the scanner configured to rescan the email for the particular type of content.

9. The method of claim 1, further comprising receiving a denial of approval for a particular email for at least one type of content, and in response to receiving the denial, discarding the email.

10. A device comprising:
one or more processors; and
one or more computer-readable media, having instructions stored thereon that, when executed by the one or more processors, cause the one or more processors to perform operations comprising:
receiving an email for processing;
prior to delivering the email, providing the email to a set of scanners, wherein one or more of the scanners:
are associated with a respective type of content; and
are configured to detect whether the email includes the respective type of content;
receiving, from the set of scanners, an identification of a plurality of types of content in the email;
for each type of content in the email:
providing the email to a user of a particular role, wherein users of the particular role are authorized to review the type of content; and
receiving, from the user, approval of the email for the type of content; and
responsive to the email being approved for each type of content, delivering the email to a recipient.

11. The device of claim 10, wherein providing and receiving the approval is performed serially for different types of content, and wherein the operations further include:
after receiving the identification of the plurality of types of content in the email, determining that a policy has been updated for a particular type of content; and
in response to the determining, providing the email to a scanner from the set of scanners configured to detect the particular type of content prior to providing the email to the user of the particular role.

12. The device of claim 10, wherein an order in which the email is provided to users of particular roles is based at least in part on an amount of time associated with prior approvals for the respective type of content for which the users of the particular roles are authorized to review.

13. The device of claim 10, wherein the operations further include:
identifying a first user role that is authorized to review multiple types of content;
wherein a number of types of content that the first user role is authorized to review is greater than a number of types of content that other user roles are authorized to review; and
wherein providing the email to the user of the particular role comprises providing the email to the user of the first user role prior to providing the email to users of other user roles.

14. The device of claim 10, wherein the operations further include:
responsive to receiving the email, setting a content identifier for each type of content to false; and
responsive to the email being reviewed for each type of content and the email being approved for each type of content, setting respective content identifiers to true.

15. A non-transitory computer-readable medium with instructions stored thereon that, responsive to execution by a processing device, causes the processing device to perform operations comprising:
receiving an email for processing;
prior to delivering the email, providing the email to a set of scanners, wherein one or more of the scanners:
are associated with a respective type of content; and
are configured to detect whether the email includes the respective type of content;
receiving, from the set of scanners, an identification of a plurality of types of content in the email;
for each type of content in the email:
providing the email to a user of a particular role, wherein users of the particular role are authorized to review the type of content; and
receiving, from the user, approval of the email for the type of content; and
responsive to the email being approved for each type of content, delivering the email to a recipient.

16. The computer-readable medium of claim 15, wherein providing and receiving the approval is performed serially for different types of content, and wherein the operations further include:
after receiving the identification of the plurality of types of content in the email, determining that a policy has been updated for a particular type of content; and
in response to the determining, providing the email to a scanner from the set of scanners configured to detect the particular type of content prior to providing the email to the user of the particular role.

17. The computer-readable medium of claim 15, wherein an order in which the email is provided to users of particular roles is based at least in part on an amount of time associated with prior approvals for the respective type of content for which the users of the particular roles are authorized to review.

18. The computer-readable medium of claim 15, wherein the operations further include:
identifying a first user role that is authorized to review multiple types of content;
wherein a number of types of content that the first user role is authorized to review is greater than a number of types of content that other user roles are authorized to review; and
wherein providing the email to the user of the particular role comprises providing the email to the user of the first user role prior to providing the email to users of other user roles.

19. The computer-readable medium of claim 15, wherein the operations further include:
responsive to receiving the email, setting a content identifier for each type of content to false; and
responsive to the email being reviewed for each type of content and the email being approved for each type of content, setting respective content identifiers to true.

20. The computer-readable medium of claim 15, wherein multiple users are assigned to a particular type of content and the email stays in quarantine until it is approved by each of the multiple users.
